(19) United States
(12) Patent Application Publication
(10) Pub. No.: US 2025/0167350 A1
(43) Pub. Date: May 22, 2025

(54) PASSIVE COOLING STRUCTURAL ENCAPSULATION SYSTEM FOR BATTERY CELLS

(71) Applicant: GM GLOBAL TECHNOLOGY OPERATIONS LLC, Detroit, MN (US)

(72) Inventors: Anthony Michael COPPOLA, Rochester Hills, MI (US); Anil K. Sachdev, Rochester Hills, MI (US); Mohammad Hamza Kirmani, Troy, MI (US); Ryan Patrick Hickey, Austin, TX (US)

(21) Appl. No.: 18/516,129

(22) Filed: Nov. 21, 2023

(51) Int. Cl. H01M 10/6569; H01M 10/613; H01M 10/643; H01M 10/653; H01M 10/6552; H01M 10/6554; H01M 50/213; H01M 50/291

(52) U.S. Cl. CPC H01M 10/6569; H01M 10/613; H01M 10/643; H01M 10/653; H01M 10/6552; H01M 10/6554; H01M 50/213; H01M 50/291

(57) ABSTRACT

A passive cooling system for battery cells includes a housing defining a cavity with a plurality of battery cells disposed in the cavity. Each of the battery cells is surrounded by a porous media and a phase change material is disposed within spaces defined by the porous media. A cold plate is disposed at a top of the cavity to cool the phase change material that is vaporized and change the vapor to a liquid.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to a passive cooling structural encapsulation system for battery cells.

Currently, battery cells in an electric vehicle are thermally managed by forced liquid cold plates. These cold plates are often in the form of ribbons placed between the cells. Circulation of the coolant requires a pump and the channels themselves require added components within the pack. The cooling ribbons are typically metal, which is electrically conductive.

Heat pipes are a related heat transportation technology that utilize phase change of a fluid in a closed volume system. In this system, the liquid is transported through the wick by capillary action in a porous media. Two-phase immersion cooling systems operate similarly but do not rely on capillary forces to transport liquid. The present disclosure uses a similar thermal cycle.

### SUMMARY

According to an aspect of the present disclosure, a passive cooling system for battery cells includes a housing defining a cavity with a plurality of battery cells disposed in the cavity. Each of the battery cells is surrounded by a porous media and a phase change material is disposed within spaces defined by the porous media. A cold plate is disposed at a top of the cavity to cool the phase change material that is vaporized and change the vapor to a liquid.

According to a further aspect, the porous media defines a plurality of vapor channels along each of the plurality of battery cells.

According to a further aspect, the plurality of vapor channels extend vertically upward along a side of the battery cells.

According to a further aspect, a sub-dividing structure is disposed in the cavity for sub-dividing the cavity into a plurality of separate compartments.

According to a further aspect, the porous media surrounding the battery cells includes an open cell foam.

According to a further aspect, the open cell foam includes one of epoxy, polyurethane and silicone.

According to a further aspect, the porous media surrounding the battery cells includes one of an aerogel and a non-organic cellular structure.

According to a further aspect, the vapor change material is dielectric.

According to a further aspect, the phase change material has a boiling point between 30-60° C. at ambient pressure.

According to a further aspect, the cold plate is liquid cooled.

According to a further aspect, the cold plate is partially exposed to ambient for cooling.

According to a further aspect, the cold plate is a top enclosure of the housing.

According to another aspect of the present disclosure, a method of making a passive cooling system for battery cells includes applying a plurality of strips of sacrificial material to an outer surface of a plurality of battery cells and inserting the plurality of battery cells into a cavity of a housing. A porous media is formed within the cavity of the housing surrounding the plurality of battery cells. The plurality of strips of sacrificial material are removed from the plurality of battery cells to form a plurality of channels within the porous media along a surface of the plurality of battery cells and the porous media is filled with a phase change material.

According to a further aspect, the sacrificial material includes one of a water soluble polymer, a combustible solid, a meltable wax and a thermally degradable polymer.

According to a further aspect, a cold plate is placed above the cavity of the housing.

According to a further aspect, a sub-dividing structure is inserted within the cavity for sub dividing the cavity into a plurality of separate compartments each including a subset of the plurality of battery cells.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a schematic cross-section of a passive battery cooling encapsulation system for battery cells;

FIG. 2 is a schematic plan view of the cell arrangement of the passive battery cooling encapsulation system for battery cells;

FIG. 3 is a schematic view of the cell arrangement of the passive battery cooling encapsulation system with a non-porous coolant containment layer; and

FIGS. 4A-4C illustrate a process for forming the vapor channels within the porous media.

In the drawings, reference numbers may be reused to identify similar and/or identical elements.

### DETAILED DESCRIPTION

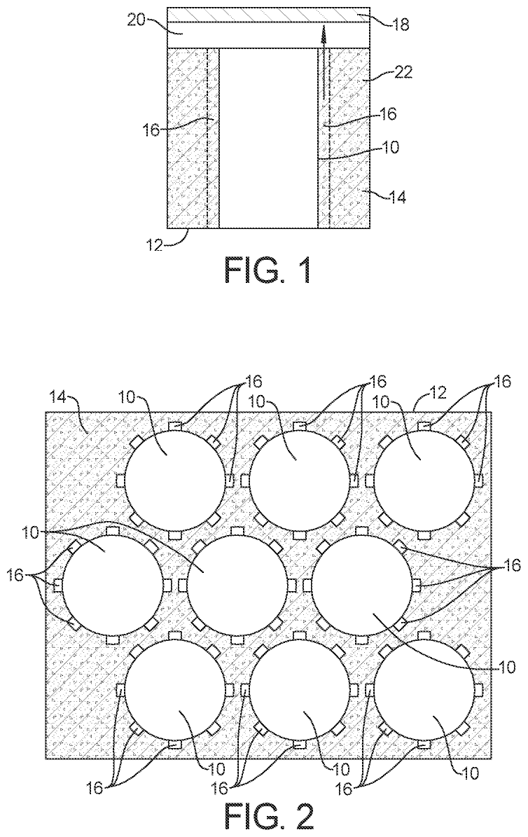

With reference to FIGS. 1 and 2, a battery cell 10 is shown within a housing 12 having a porous media such as an open pore foam 14 within the cavity surrounding the battery cell 10. The open pore foam 14 can includes one of an epoxy, a polyurethane, a silicone, an aerogel and a non-organic cellular structure. A plurality of vapor channels 16 are formed within the open pore foam 14 along a side surface of the batter cell. A cold plate 18 is disposed in a top of the housing 12. An electrical bussing system 20 is contained within the cavity and is connected to the battery cells 10. The electrical bussing system 20 can be part of the cold plate 18. The cold plate 18 can be liquid cooled and can be partially exposed to ambient for cooling. The cold plate 18 can also be a top enclosure of the housing 12.

A phase change working fluid 22 is filled within the pores of the open pore foam 14 surrounding the battery cells 10. FIG. 2 shows a plurality of battery cells 10 within the housing 12 with the open pore foam 14 including a plurality of vapor channels 16 extending upward along a side surface of each battery cell 10. The vapor change material can be dielectric and a boiling point between 30-60° C. at ambient pressure. Vapor change materials of this type are known in the art.

In operation, as the batteries 10 heat up during charging and discharging, the phase change fluid 22 heats up and is changed to a vapor. The vapor rises up following arrow A along the vapor channels 16 and is cooled at the top of the housing 12 by the cold plate 18. The cooled vapor then condenses on the cold plate and drips down into the open pore foam 14. Capillary action at the point of vaporization within the open pore foam transports the fluid back to the cell wall following arrow B.

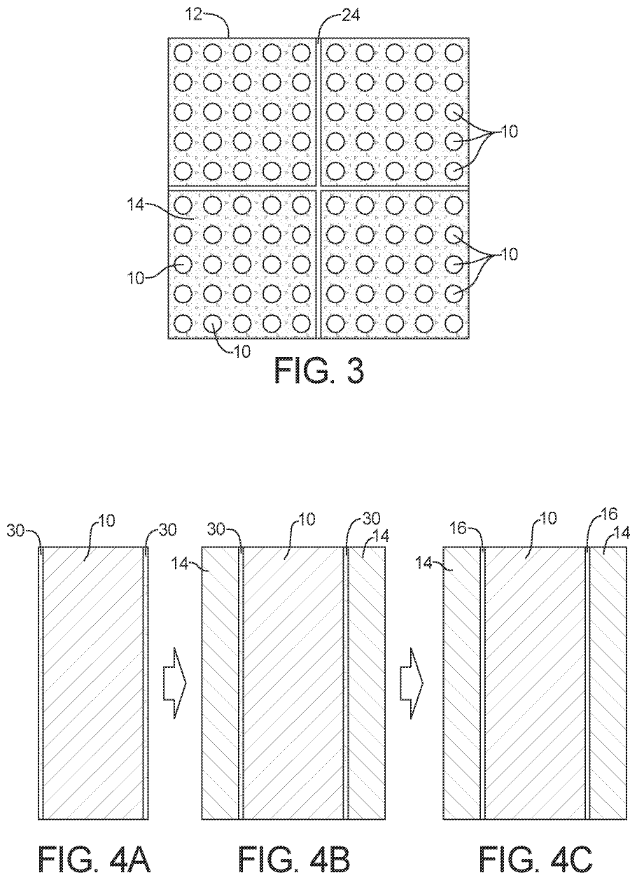

With reference to FIG. 3, the cavity of the housing 12 is shown further including a sub-dividing structure 24 for sub-dividing the cavity into a plurality of separate compartments each containing a plurality of the battery cells 10. The sub-dividing structure 24 maintains even coolant levels throughout the pack even under prolonged uneven vehicle exposure such as when the vehicle is parked on a slope. In addition, the sub-dividing structure can reduce sloshing of the phase change liquid 22 during vehicle operation.

With reference to FIGS. 4A-4C, a process for forming the vapor channels 16 along the surface of the battery cells 10 will now be described. During the assembly process as shown in FIG. 4A, a plurality of strips of sacrificial material 30 are formed on the side surface of the battery cells 10. As shown in FIG. 4B, the porous material 14 is formed around the battery cells 10 and the sacrificial material 30. With reference to FIG. 4C, the sacrificial material 30 is removed to form the channels 16. The sacrificial material 30 can be a wax, a water soluble material, a combustible material or other thermally degradable material. The sacrificial material can be melted away, dissolved, degraded or otherwise removed to provide a void defining the channels 16.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

What is claimed is:

1. A passive cooling system for battery cells, comprising:
a housing defining a cavity;
a plurality of battery cells disposed in the cavity of the housing;
each of the battery cells being surrounded by a porous media;
a phase change material disposed within spaces defined by the porous media; and
a cold plate disposed at an end of the cavity.

2. The passive cooling system for battery cells according to claim 1, wherein the porous media defines a plurality of vapor channels along each of the plurality of battery cells.

3. The passive colling system for battery cells according to claim 2, wherein the plurality of vapor channels extend vertically upward along a side of the battery cells.

4. The passive cooling system for battery cells according to claim 1, further comprising a sub-dividing structure disposed in the cavity for sub-dividing the cavity into a plurality of separate compartments.

5. The passive cooling system for battery cells according to claim 1, wherein the porous media surrounding the battery cells includes an open cell foam.

6. The passive cooling system for battery cells according to claim 5, wherein the open cell foam includes one of epoxy, polyurethane and silicone.

7. The passive cooling system for battery cells according to claim 1, wherein the porous media surrounding the battery cells includes one of an aerogel and a non-organic cellular structure.

8. The passive cooling system for battery cells according to claim 1, wherein the phase change material is dielectric.

9. The passive cooling system for battery cells according to claim 1, wherein the phase change material has a boiling point between 30-60° C. at ambient pressure.

10. The passive cooling system for battery cells according to claim 1, wherein the cold plate is liquid cooled.

11. The passive cooling system for battery cells according to claim 1, wherein the cold plate is partially exposed to ambient for cooling.

12. The passive cooling system for battery cells according to claim 1, wherein the cold plate is a top enclosure of the housing.

13. A method of making a passive cooling system for battery cells, comprising:
applying a plurality of strips of sacrificial material to an outer surface of a plurality of battery cells;
inserting the plurality of battery cells into a cavity of a housing;
forming a porous media within the cavity of the housing surrounding the plurality of battery cells; and
removing the plurality of strips of sacrificial material from the plurality of battery cells to form a plurality of channels within the porous media along a surface of the plurality of battery cells;
filling the porous media with a phase change material.

14. The method according to claim 13, wherein the sacrificial material includes one of a water soluble polymer, a combustible solid, a meltable wax and a thermally degradable polymer.

15. The method according to claim 13, further comprising placing a cold plate above the cavity of the housing.

16. The method according to claim 15, wherein the cold plate is liquid cooled.

17. The method according to claim 15, wherein the cold plate is partially exposed to ambient for cooling.

18. The method according to claim 13, further including inserting a sub-dividing structure within the cavity for sub dividing the cavity into a plurality of separate compartments each including a subset of the plurality of battery cells.

19. The method according to claim 13, wherein the phase change material is dielectric.

20. The method according to claim 13, wherein the porous media is an open cell foam.
